(19) United States
(12) Patent Application Publication
(10) Pub. No.: US 2025/0185867 A1
(43) Pub. Date: Jun. 12, 2025

(54) METHOD FOR CONTROLLING MOVEMENT OF AUTONOMOUS MOBILE DEVICE

(71) Applicant: Qfeeltech (Beijing) Co., Ltd., Beijing (CN)

(72) Inventor: Shaoxuan GAO, Beijing (CN)

(21) Appl. No.: 19/056,714

(22) Filed: Feb. 18, 2025

Related U.S. Application Data
(63) Continuation of application No. PCT/CN2022/113676, filed on Aug. 19, 2022.

(51) Int. Cl. A47L 11/40; G05D 1/628; G05D 1/646; G05D 105/10; G05D 107/40; G05D 111/10; G05D 111/50

(52) U.S. Cl. CPC A47L 11/4011; A47L 11/4061; G05D 1/628; G05D 1/646; A47L 2201/04; G05D 2105/10; G05D 2107/40; G05D 2111/17; G05D 2111/54

(57) ABSTRACT

A method for controlling movement of an autonomous mobile device is provided. The method includes controlling the autonomous mobile device to move along an edge of a first obstacle. The method also includes determining detection of a second obstacle in a moving direction, the first obstacle and the second obstacle forming a corner. The method also includes determining a first location of the autonomous mobile device. The method also includes determining a projected location adjacent the second obstacle. The method also includes determining a curved path connecting the first location and the projected location. The method also includes controlling the autonomous mobile device to move from the first location to the projected location along the curved path.

### CROSS REFERENCE TO RELATED APPLICATION

This application is a continuation of International Application No. PCT/CN2022/113676, filed on Aug. 19, 2022, the content of which is incorporated herein by reference in its entirety.

### TECHNICAL FIELD

The present disclosure generally relates to the technical field of automatic control of autonomous mobile devices and, more specifically, to a method for controlling movement of an autonomous mobile device.

### BACKGROUND

Autonomous mobile devices such as devices that can autonomously carry out pre-set or pre-configured tasks within a pre-defined closed space (i.e., a work environment) have been widely used in consumer and industrial applications. Currently available autonomous mobile devices typically include, but are not limited to, cleaning robots (e.g., smart floor sweeping robots, smart floor mopping robots, window cleaning robots, etc.), escort or companion type mobile robots (e.g., smart electronic pets, nanny robots), service type mobile robots (e.g., robots for restaurants, hotels, conference room reception), industrial inspection smart devices (e.g., electric power line inspection robots, smart forklift, etc.), and security robots (e.g., consumer or commercial smart security robots).

An autonomous mobile device typically can move autonomously within a limited space. For example, a cleaning robot or a companion type mobile robot typically operates indoor. Service type mobile robots typically operate within a limited space in a hotel, conference room, etc. Currently, some autonomous mobile devices can obtain locations of obstacles through sensing environmental information, thereby establishing a two-dimensional planar map for the environment, e.g., the space in which the autonomous mobile devices operate. For example, an autonomous mobile device may directly measure distances to obstacles through a laser based distance measurement device, and may convert the distances into coordinates. Alternatively, the autonomous mobile device may obtain coordinates of an obstacle based on a wheel encoder, an inertial measurement unit (“IMU”), and a collision sensor that detects collision with the obstacle. In some situations, the autonomous mobile device may capture images of objects in the environment through a camera (e.g., an ordinary camera). The autonomous mobile device may determine coordinates of an obstacle, through a visual simultaneous localization and mapping (“vSLAM”) algorithm, based on the captured images and motion data obtained through dead reckoning sensors such as the wheel encoder and IMU. The autonomous mobile device may obtain a map for the environment based on the coordinates of the obstacles. The obstacle refers to any physical object the autonomous mobile device senses or detects in a work zone that blocks the autonomous mobile device from moving to a target space, such as a wall, a floor cabinet, a bed not having a sufficient space at a lower portion for the autonomous mobile device to move through, legs of a chair, refrigerator, toilet, etc. The autonomous mobile device may detect the physical object that blocks the passage of the autonomous mobile device based on an onboard collision sensor or a proximity sensor. Another example of the obstacle is a magnetic strip disposed on a floor or an object. The magnetic field of the magnetic strip may be detected by a Hall-effect element disposed at the autonomous mobile device. The autonomous mobile device may be controlled, e.g., through an algorithm executed by a processor disposed on the autonomous mobile device, to refrain from traversing the location or space where the magnetic field is present. Another example of the obstacle is stairs leading to a lower floor. When the autonomous mobile device moves to an edge of the stairs, a cliff sensor downwardly disposed at a front portion of the autonomous mobile device can detect the stairs leading to the lower floor. As such, the stairs leading to the lower floor can function as an obstacle to block the passage of the autonomous mobile device. The location where the stairs start to descend may be deemed as an obstacle. Objects that do not block the autonomous mobile device from moving into the floor space occupied by the objects are not obstacles. For example, some beds or tables may have a space with a sufficient height at a lower portion adjacent the floor, which may allow a cleaning robot to move therein under the beds or tables. The beds or tables configured with a sufficiently high space may not be treated as obstacles. The legs of the beds or the legs of the tables may be obstacles that block the autonomous mobile device, because the legs of the beds or the legs of the tables can block the autonomous mobile device (e.g., the cleaning robot) from moving into the locations occupied by the legs.

In a conventional autonomous mobile device, when the autonomous mobile device moves along a boundary or edge of a first obstacle and arrives at a corner location, i.e., a location where the first obstacle and a second obstacle (or boundaries of the two obstacles) are substantially perpendicular to one another, the autonomous mobile device may spin around its own vertical axis (e.g., a predetermined spinning axis passing through the autonomous mobile device) at a fixed location for, e.g., 90 degrees, such that the autonomous mobile device can change its forward moving direction, and move along the second obstacle. The spinning may not be an issue for an autonomous mobile device having a substantially round, circular shape, in which the circumferential portions of the housing may have substantially equal distance to the spinning axis. Thus, as the autonomous mobile device having a circular shape spins, the circumferential portions of the housing of the autonomous mobile device may not collide with the first obstacle. However, for an autonomous mobile device having an non-circular shape, such as an oval shape, a rectangular shape, or any shape in which the circumferential portions of the housing of the autonomous mobile device have different distances to the spinning axis, a portion of the housing having the furthest distance to the spinning axis of the autonomous mobile device may collide with the first obstacle. For example, when the spinning is initially started, a first circumferential portion of the housing that is closest to the obstacle may have a first distance to the spinning axis. As the autonomous mobile device spins, a second circumferential portion of the housing having a larger, second distance to the spinning axis may collide with the obstacle. Thus, there is a need for an improved algorithm for controlling the movement (e.g., turning) of the autonomous mobile device.

### SUMMARY OF THE DISCLOSURE

Embodiments of the present disclosure provide a method executable by a processor of an autonomous mobile device for controlling the movement of the autonomous mobile device. The method may control the turning of the autonomous mobile device at a corner location, or at any location where a turn is needed to change the moving path of the autonomous mobile device. The method disclosed herein resolve the technical issues associated with the existing conventional autonomous mobile devices, i.e., when making a turn or when spinning at a location adjacent an obstacle, a circumferential portion of housing of the autonomous mobile device having a non-circular shape may collide with the obstacle.

According to an aspect of the present disclosure, a method for controlling movement of an autonomous mobile device is provided. The method includes controlling the autonomous mobile device to move along an edge of a first obstacle. The method also includes determining detection of a second obstacle in a moving direction, the first obstacle and the second obstacle forming a corner. The method also includes determining a first location of the autonomous mobile device. The method also includes determining a projected location adjacent the second obstacle. The method also includes determining a curved path connecting the first location and the projected location. The method also includes controlling the autonomous mobile device to move from the first location to the projected location along the curved path.

According to another aspect of the present disclosure, a method for controlling movement of an autonomous mobile device in a cornrow pattern is provided. The method includes controlling the autonomous mobile device to move along a first long path in the cornrow pattern. The method also includes determining detection of an obstacle in a moving direction along the first long path. The method also includes determining a first location of the autonomous mobile device. The method also includes determining a projected location on a second long path in the cornrow pattern, the second long path being parallel with the first long path. The method also includes determining a curved path connecting the first location and the projected location. The method also includes controlling the autonomous mobile device to move from the first location to the projected location along the curved path.

According to another aspect of the present disclosure, a method for controlling movement of an autonomous mobile device in a cornrow pattern is provided. The method includes controlling the autonomous mobile device to move along a first long path in the cornrow pattern. The method also includes determining detection of an obstacle in a moving direction along the first long path. The method also includes determining a first location of the autonomous mobile device. The method also includes determining a first projected location. The methods also includes determining a first curved path connecting the first location and the first projected location. The method also includes controlling the autonomous mobile device to move from the first location to the first projected location along the first curved path. The method also includes determining a second projected location on the second long path. The method also includes determining a second curved path connecting the first projected location and the second projected location. The method further includes controlling the autonomous mobile device to move from the first projected location to the second projected location.

According to another aspect of the present disclosure, an autonomous mobile device is provided. The autonomous mobile device includes a sensor configured to detect an obstacle. The autonomous mobile device includes a motion unit configured to move the autonomous mobile device along a surface. The autonomous mobile device includes a processor configured to control the motion unit to control movement of the autonomous mobile device based on detection of the obstacle. The processor is configured to perform a method including controlling the motion unit to move the autonomous mobile device to along an edge of a first obstacle. The method also includes determining detection of a second obstacle in a moving direction, the first obstacle and the second obstacle forming a corner. The method also includes determining a first location of the autonomous mobile device. The method also includes determining a projected location adjacent the second obstacle. The method also includes determining a curved path connecting the first location and the projected location. The method also includes controlling the motion unit to move the autonomous mobile device from the first location to the projected location along the curved path.

According to another aspect of the present disclosure, an autonomous mobile device is provided. The autonomous mobile device includes a sensor configured to detect an obstacle. The autonomous mobile device also includes a motion unit configured to move the autonomous mobile device along a surface. The autonomous mobile device also includes a processor configured to control the motion unit to control movement of the autonomous mobile device based on detection of the obstacle. The processor is configured to perform a method including controlling the autonomous mobile device to move along a first long path in the cornrow pattern. The method also includes determining detection of an obstacle in a moving direction along the first long path. The method also includes determining a first location of the autonomous mobile device. The method also includes determining a projected location on a second long path in the cornrow pattern, the second long path being parallel with the first long path. The method also includes determining a curved path connecting the first location and the projected location. The method also includes controlling the motion unit to move the autonomous mobile device from the first location to the projected location along the curved path.

According to another aspect of the present disclosure, an autonomous mobile device is provided. The autonomous mobile device includes a sensor configured to detect an obstacle. The autonomous mobile device also includes a motion unit configured to move the autonomous mobile device along a surface. The autonomous mobile device also includes a processor configured to control the motion unit to control movement of the autonomous mobile device based on detection of the obstacle. The processor is configured to perform a method including controlling the motion unit to move the autonomous mobile device along a first long path in a cornrow pattern. The method also includes determining detection of an obstacle in a moving direction along the first long path. The method also includes determining a first location of the autonomous mobile device. The method also includes determining a first projected location. The method also includes determining a first curved path connecting the first location and the first projected location. The method also includes controlling the motion unit to move the autonomous mobile device from the first location to the first projected location along the first curved path. The method also includes determining a second projected location on the second long path. The method also includes determining a second curved path connecting the first projected location and the second projected location. The method also includes controlling the motion unit to move the autonomous mobile device from the first projected location to the second projected location.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The accompanying drawings are provided to illustrate some, but not all, embodiments of the present disclosure to facilitate the understanding of the present disclosure. The drawings are parts of the present disclosure. The illustrative embodiments and the descriptions are for explaining the principles of the present disclosure, and are not intended to limit the scope of the present disclosure. In the drawings:

FIG. 1A is a schematic perspective view of an autonomous mobile device, according to an embodiment of the present disclosure;

FIG. 1B is a schematic bottom view of the autonomous mobile device shown in FIG. 1A, according to an embodiment of the present disclosure;

FIG. 2A and FIG. 2B schematically illustrate an autonomous mobile device having a non-circular shape making a turn at a corner, according to conventional technologies;

FIG. 3A and FIG. 3B schematically illustrate movement control of an autonomous mobile device in a wall-following mode, according to an embodiment of the present disclosure;

FIG. 3C schematically illustrates movement control of an autonomous mobile device in a cornrow mode according to conventional technologies;

FIG. 3D schematically illustrates movement control of an autonomous mobile device in a cornrow mode, according to an embodiment of the present disclosure;

FIG. 3E schematically illustrates travel paths of an autonomous mobile device in a typical cornrow pattern (or mode);

FIGS. 3F and 3G schematically illustrate movement control of an autonomous mobile device in a cornrow mode, according to another embodiment of the present disclosure; and

FIGS. 4A-4C are flowcharts illustrating methods for controlling movement of an autonomous mobile device according to various embodiments of the present disclosure.

### DETAILED DESCRIPTION

To assist a person having ordinary skills in the art in understanding the technical solutions of the present disclosure, various embodiments of the present disclosure will be explained in detail, with reference to the accompanying drawings. The embodiments illustrated in the drawings and described below are merely some, but not all, embodiments of the present disclosure. Based on the illustrated embodiments, a person having ordinary skills in the art can derive other embodiments without creative efforts. The derived embodiments are also within the scope of protection of the present disclosure.

It should be understood that in the specification, claims, and drawings of the present disclosure, relational terms such as “first” and “second,” etc., are only used to distinguish similar objects, and do not necessarily describe a specific order or sequence. It should be understood that data modified by such terms may be exchanged in suitable situations, such that the embodiments described herein can be implemented in orders or sequences other than those described or illustrated herein. In addition, the term “comprise,” “include,” and their variations are intended to mean non-exclusive inclusion. For example, processes, methods, systems, products, or devices (or apparatus) including a series of steps or units are not limited to the listed steps or units, and may also include other steps or units that are not explicitly listed or that are inherent to the processes, methods, products, or devices.

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

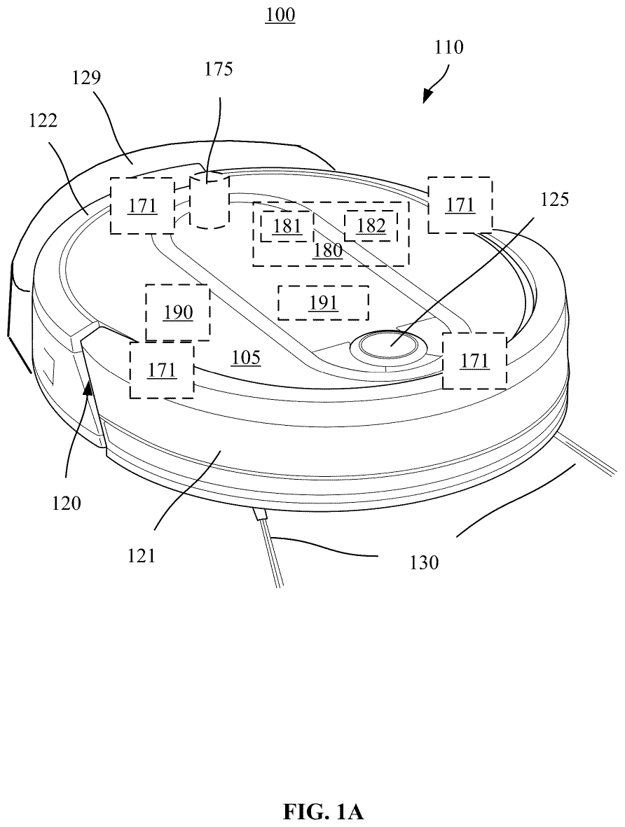

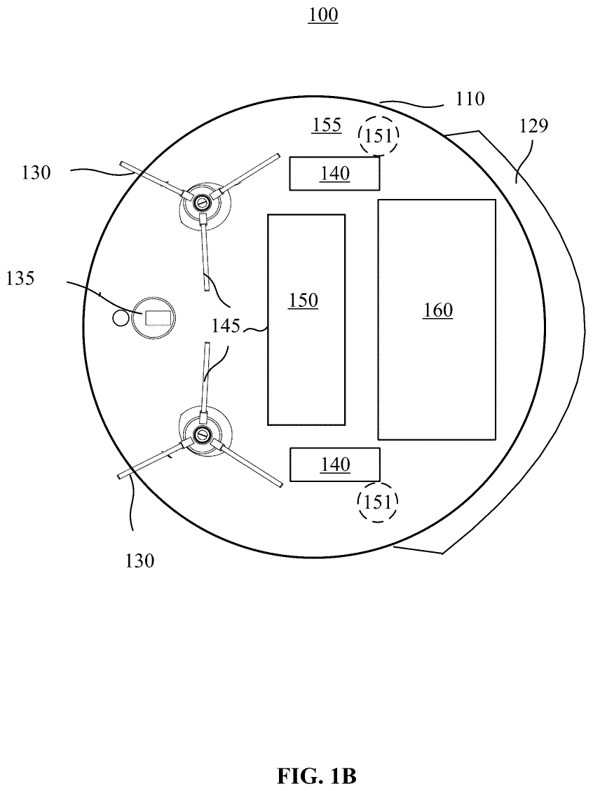

FIG. 1A schematically illustrates a perspective view of an autonomous mobile device 100, according to an embodiment of the present disclosure. The autonomous mobile device 100 may be any suitable type of autonomous mobile device, such as a floor cleaning (e.g., vacuum, sweeping, and/or mopping) robot, a window cleaning robot, etc. For illustrative purposes, a floor cleaning robot is used as an example of the autonomous mobile device 100. The autonomous mobile device 100 may include a main body 110. The main body 110 may have a non-circular shape. The autonomous mobile device 100 may be configured to be capable of spinning at a same location (e.g., without moving forwardly or backwardly) around a vertical spinning axis passing through a certain point on the main body 110. Due to the non-circular shape, circumferential portions of the main body 110 may have different distances to the spinning axis of the autonomous mobile device 100. In some embodiments, the main body 110 may include a housing 105 that may have a rectangular shape or an oval shape. In some embodiments, the housing 105 may have a circular shape, and a water tank 129 may be detachably coupled to the housing 105. With the water tank 129 attached to the housing 105, the overall shape of the main body 110 may be non-circular. It is understood that the shape of the main body 110 is not limited to the above examples. The housing 105 may include a stop housing portion and circumferential side housing portions, which together may define an inner space for accommodating various elements, parts, or components of the autonomous mobile device 100, such as motion devices, motors, cleaning devices, etc.

The main body 110 may include a first bumper (or first cover, front bumper) 121 and a second bumper (or second cover, rear bumper) 122 at a circumferential side of the main body 110. The bumpers 121 and 122 may be parts of the housing 105, or may be treated as separate parts different from the housing 105. The first bumper 121 may be separated from the second bumper 122 by one or more gaps 120. At least one of the first bumper 121 or the second bumper 122 may be resiliently coupled with the other portions of the housing 105 or other portions of the main body 110 through an elastic member, such as a spring (not shown). When the autonomous mobile device 100 collides with an obstacle, such as a wall or furniture, the first bumper 121 or the second bumper 122 may retract when pushed by the obstacle, thereby providing a buffer or an impact absorption for the autonomous mobile device 100. One or more collision sensors may be disposed at or behind the first bumper 121 and/or the second bumper 122. When the first bumper 121 and/or the second bumper 122 collides with an object, the one or more collision sensors may detect the collision and generate a signal indicating the occurrence of the collision. In some embodiments, the collision sensor may detect a potential collision and generate a warning signal, or trigger a controller (such as a processor 190) to make a collision avoidance control.

The autonomous mobile device 100 may also include an environmental data sensing device configured to acquire environmental data of a work environment (e.g., a room) in which the autonomous mobile device 100 moves or operates. The environmental data sensing device may include at least one of a camera 125 or a distance measuring device 175. In some embodiments, the autonomous mobile device 100 may include both the camera 125 and the distance measuring device 175. The camera 125 may be configured to capture one or more images of the environment (e.g., room) in which the autonomous mobile device 100 moves. For illustrative purposes, the camera 125 is shown as being mounted at the top portion of the housing 105 of the autonomous mobile device 100. It is understood that the camera 125 may be mounted at any other portion of the autonomous mobile device main body 110, e.g., at the front bumper 121. Although one camera 125 is shown, it is understood that the autonomous mobile device 100 may include multiple cameras 125 disposed at multiple portions of the autonomous mobile device 100, such as at the back bumper 122, at the left and right side of the housing 105, etc. The orientation of the camera 125 may be in any suitable directions, such as facing front, facing back, facing sides, facing up (e.g., ceiling of a room), facing a direction forming an acute angle relative to the moving direction of the autonomous mobile device 100, etc. In some embodiments, the facing direction of the camera 125 may be adjustable manually or automatically through an electrical adjustment mechanism, such as a motor. In some embodiments, the facing direction of the camera 125 may be fixed.

The autonomous mobile device 100 may include the processor 190 disposed within the inner space enclosed by the housing 105. The processor 190 may include a controller, or may be a controller, or may be part of a controller. The processor 190 may be any suitable processor, such as a central processing unit (“CPU”), a graphics processing unit (“GPU”), an application-specific integrated circuit (“ASIC”), a programmable logic device (“PLD”), or a combination thereof. Other processors not listed above may also be used. The processor 190 may be implemented as software, hardware, firmware, or a combination thereof. For example, the processor 190 may include circuits, logic gates, and/or software codes encoded therein, etc.

The processor 190 may perform various control functions to control the operations and/or movements of the autonomous mobile device 100. The processor 190 may process data and/or signals received from various sensors (or sensing devices) equipped in or on the autonomous mobile device 100, or received from another external device electrically coupled with the autonomous mobile device 100. Based on analysis of the data and/or signals, the processor 190 may control the operation and/or movement of the autonomous mobile device 100. For example, the processor 190 may execute computer-readable instructions or codes to perform a method for controlling the movement, such as turning, of the autonomous mobile device 100 to avoid collision with a detected obstacle.

The autonomous mobile device 100 may include a data storage device 191 configured to store data, signals, images, processor-executable (or computer-executable) instructions or codes, etc. The data storage device 191 may also be referred to as a non-transitory computer-readable medium. The non-transitory computer-readable medium may be any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc. The processor 190 may be electrically coupled with the data storage device 191, e.g., through a data transmission or communication bus. The processor 190 may store data into the data storage device 191, or may retrieve data from the data storage device 191.

The autonomous mobile device 100 may include a communication device 180 configured to communicate with another device, such as a cloud server, a docking station of the autonomous mobile device 100, a smart phone, another similar autonomous mobile device operating in the same work environment, etc. The communication device 180 may be at least partially disposed at the housing 105, or may be entirely disposed within the inner space enclosed by the housing 105. The communication device 180 may include a receiver 181 configured to receive data or signals from another device, such as a sensor or sensing device, a cloud server, a smart phone, etc. The communication device 180 may also include a transmitter 182 configured to transmit data or signals to another device. In some embodiments, the receiver 181 and the transmitter 182 may be a single integral transceiver. The autonomous mobile device 100 may further include one or more cleaning devices, such as one or more brushes. For illustrative purposes, FIG. 1A shows two side brushes 130.

In some embodiments, the distance measuring device 175 may be configured to measure a distance between the autonomous mobile device 100 and an obstacle, such as a wall, a furniture, a human being, an animal, a. For example, in some embodiments, the distance measuring device 175 may be a laser-based distance measuring device, such as Light Detection and Ranging (“Lidar”) sensor.

The distance measuring device 175 and/or the camera 125 may be configured as a sensor for detecting an obstacle. For example, the processor 190 may identify an obstacle located in front of the autonomous mobile device 100 and/or in other directions around the autonomous mobile device 100 based on signals received from the Lidar sensor (an example of the distance measuring device 175). In some embodiments, the processor 190 may identify an obstacle in front of the autonomous mobile device 100 and/or in other directions around the autonomous mobile device 100 based on analysis of one or more environmental images captured by the camera 125. In some embodiments, one or more additional proximity sensors 171 may be disposed at one or more suitable locations on or in the autonomous mobile device 100, and may be configured to detect an obstacle within a predetermined distance at one or more sides of the autonomous mobile device 100.

The water tank 129 shown in FIG. 1A may be configured to store water or any other suitable liquid for cleaning a floor. In some embodiments of the autonomous mobile device 100, the water tank 129 may be replaced by a trash storage bin.

FIG. 1B is a schematic illustration of a bottom view of the structural configuration of the autonomous mobile device 100, according to an embodiment of the present disclosure. Elements or structures shown in the bottom view are based on the autonomous mobile device 100 being a floor cleaning device. When the autonomous mobile device 100 is another type of autonomous device, the elements and structures may be different from those shown in FIG. 1B. The bottom of the main body 110 of the autonomous mobile device 100 may include a bottom surface or plate 155. The bottom surface 155 and the housing 105 may define the inner space in which various elements of the autonomous mobile device 100 may be disposed or at least partially disposed. In some embodiments, the bottom surface 155 may be formed by a plurality of surfaces, although for illustrative purposes, the bottom surface 155 is shown as a single piece. A sweeping unit 145 may be mounted to the bottom surface 155. The sweeping unit 145 may include the side brushes 130 and a main brush 150 disposed at a relatively center location of the bottom surface 155. The side brushes 130 and/or the main brush 150 may be mounted to the bottom surface 155, or may be mounted to other components inside the autonomous mobile device 100 and may extend out of the bottom surface 155 through an opening provided at the bottom surface 155. Although not shown, in some embodiments, the main brush 150 may be configured to sweep dirt or trash on the floor into a trash storage tank disposed inside the autonomous mobile device 100, at a top portion, or a side portion of the autonomous mobile device 100, or to sweep dirt or trash such that they may be vacuumed into a vacuum port.

The autonomous mobile device 100 may include a motion mechanism (or motion unit) configured to enable the autonomous mobile device 100 to move along a surface (e.g., a floor, a ground). The motion mechanism may include a wheel assembly. The wheel assembly may include an omnidirectional wheel 135 disposed at a front portion of the bottom surface 155. The omnidirectional wheel 135 may be a non-driving, passively rotating wheel. The wheel assembly may also include at least two driving wheels 140 disposed at two sides (e.g., left and right sides) of the bottom surface 155. The positions of the omnidirectional wheel 135 and the two driving wheels 140 may form a triangle, as shown in FIG. 1B, to provide a stable support to the main body 110 of the autonomous mobile device 100. In some embodiments, the driving wheels 140 may be rotatable around a rotation axis passing through a center of symmetry of the driving wheels 140. In some embodiments, the driving wheels 140 may not be rotatable around an axis perpendicular to the bottom surface 155. The omnidirectional wheel 135 may freely rotate around an axis perpendicular to the bottom surface 155, and around an axis passing through a center of symmetry of the omnidirectional wheel 135. The omnidirectional wheel 135 and the driving wheels 140 together move the autonomous mobile device 100 in any desirable direction. The at least two driving wheels 140 may be independently driven by at least two electric motors 151 disposed inside the main body 110. Although two motors 151 are shown for illustrative purposes, in some embodiments, the at least two driving wheels 140 may be driven by a single motor. The motors 151 are parts of the motion mechanism. When the two driving wheels 140 are driven at different speeds, the rotation speed differential of the driving wheels 140 may cause the autonomous mobile device 100 to turn (i.e., spin at the same location or rotate while moving forward or backward). In some embodiments, the driving wheels 140 may be rotatable also around an axis perpendicular to the bottom surface 155.

In some embodiments, the autonomous mobile device 100 may include a mopping mechanism 160 disposed at the bottom surface 155. The mopping mechanism 160 may include at least one movable mopping plate attached with a mop to mop the surface to be cleaned (e.g., a floor). For illustrative purposes, the mopping mechanism 160 is shown as a rectangle in FIG. 1B. The mopping mechanism 160 may have any suitable shapes, such as a round shape, a square shape, a triangle shape, or a portion or a combination thereof. When the autonomous mobile device 100 is another type of cleaning device, the mopping mechanism 160 may be replaced by another suitable type of cleaning mechanism. The processor 190 shown in FIG. 1A may control various components of the autonomous mobile device 100, including the motion mechanism (or motion unit), and the sweeping unit 145, and the mopping mechanism 160. In some embodiments, the motion mechanism, the sweeping unit 145, and the mopping mechanism 160 may share motors. In some embodiments, the motion mechanism, the sweeping unit 145, and the mopping mechanism 160 may be independently driven by separate motors. In some embodiments, when the autonomous mobile device 100 is equipped with the vacuum function instead of the mopping function, the element 160 may be a vacuum port.

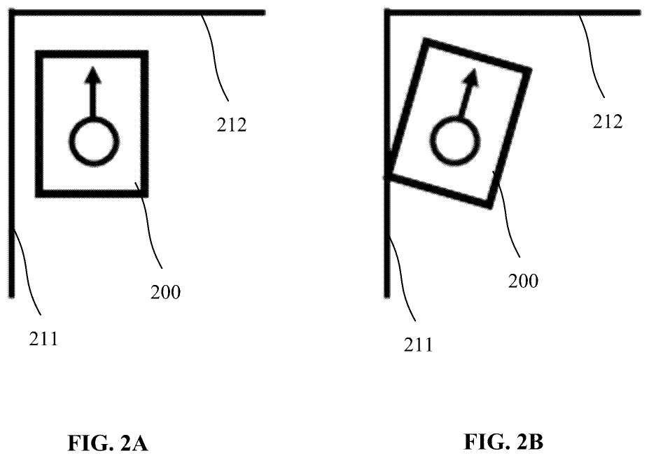

FIG. 2A and FIG. 2B illustrate an autonomous mobile device 200 having a non-circular shape (e.g., a non-circular housing) making a turn at a corner formed by two obstacles, according to conventional technologies. The autonomous mobile device 200 is shown as having a rectangular shape, although the autonomous mobile device 200 may have other non-circular shapes, such as an oval shape, or an irregular shape. The autonomous mobile device 200 may move in a wall-following mode at a corner formed by two obstacles, a first wall 211 (or first obstacle 211) and a second wall 212 (or second obstacle 212). The walls 211 and 212 may be substantially perpendicular. In conventional technologies, when the autonomous mobile device 200 is at a location adjacent the first wall 211, the autonomous mobile device 200 may detect the second wall 212 located in front of the mobile device 200 in the current moving direction. The autonomous mobile device 200 may spin around a vertical spinning axis that passes through a pre-set point on the body of the autonomous mobile device 200. Depending on the angle formed by the first wall 211 and the second wall 212, the spin may be performed for a certain angle, e.g., 90 degrees. In the example shown in FIG. 2A and FIG. 2B, the walls 211 and 212 are presumed to be perpendicular to one another. Initially, the autonomous mobile device 200 moves following the first wall 211. The autonomous mobile device 200 may spin for 90 degrees to change its moving direction for 90 degrees, and then move along the second wall 212. However, if the distance from the autonomous mobile device 200 to the first wall 211 is not sufficiently large at the location where the spinning takes place, during the spinning process, because of the non-circular shape, a portion of the autonomous mobile device 200 having a furthest distance to the spinning axis may collide with the first wall 211.

Similar issues may be encountered in other scenarios in conventional technologies. For example, when operating in a cornrow mode using conventional technologies, the autonomous mobile device 200 may need to change its direction and may need to rotate in place (i.e., spin around its own vertical spinning axis), e.g., after the autonomous mobile device 200 encounters or detects an obstacle in the current moving direction. For example, after detecting the obstacle in front of the autonomous mobile device 200 in the current moving direction, the autonomous mobile device 200 may move backwardly for a predetermined distance, and may then rotate in place. When rotating in place (e.g., spinning around its own vertical spinning axis), due to the non-circular shape, the rear portion or another portion of the autonomous mobile device 200 may collide with the obstacle on the side. The collision may cause damages to the obstacle and/or the autonomous mobile device 200.

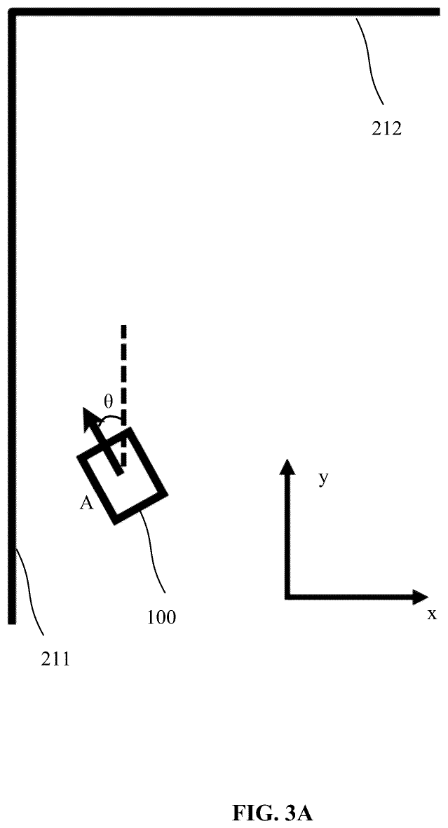

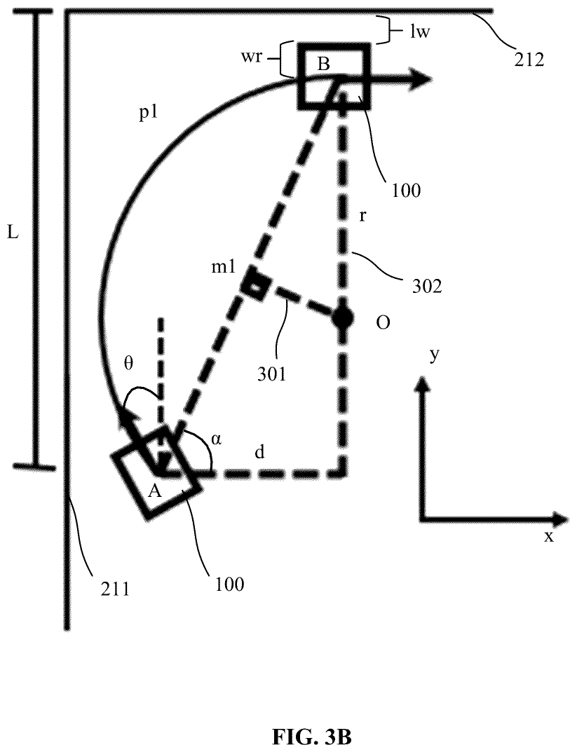

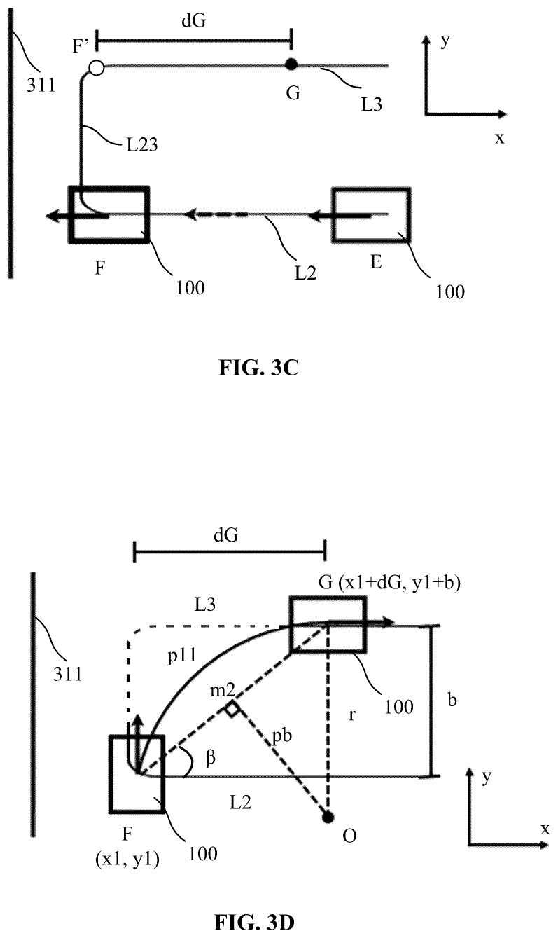

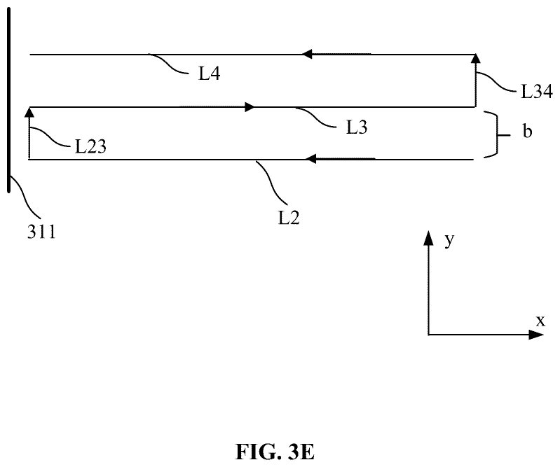

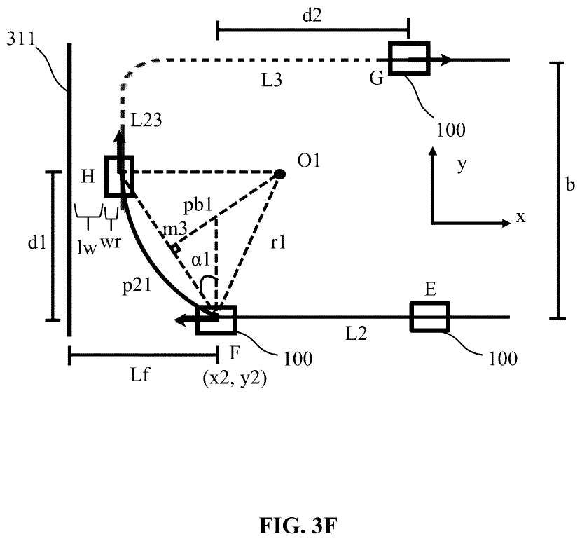

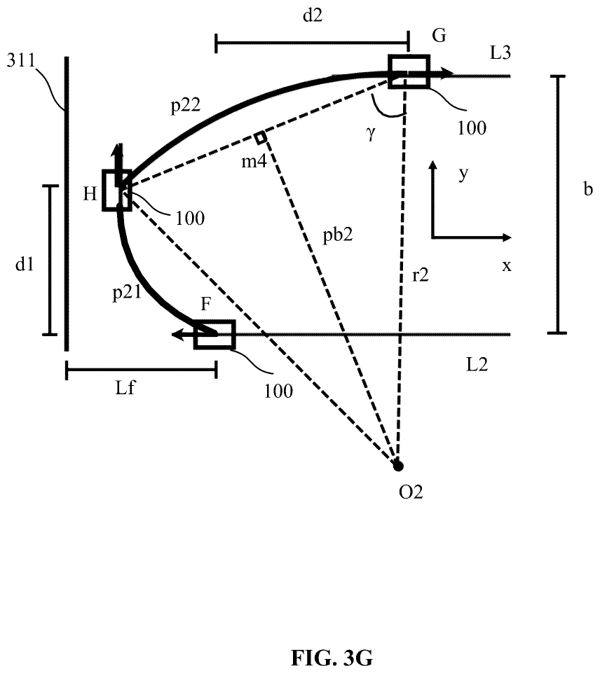

FIG. 3A and FIG. 3B schematically illustrate a method for controlling movement (or movement control) of the autonomous mobile device 100 in the wall-following mode to avoid collision with the wall, according to an embodiment of the present disclosure. FIG. 3A shows that the autonomous mobile device 100 moves in the wall-following mode in a work environment. The first wall 211 is located at the left side of the autonomous mobile device 100. The autonomous mobile device 100 moves forwardly following the first wall 211. In some embodiments, while moving forwardly following the first wall 211, the autonomous mobile device 100 may detect the second wall 212 in the moving direction in front of the autonomous mobile device at a distance L (shown in FIG. 3B). If the distance L is greater than a predetermined distance such that the autonomous mobile device 100 can make a turn along a curved path without colliding with the first wall 211, the current location may be used as a first location A shown in FIG. 3B. The autonomous mobile device 100 may obtain coordinates of the current location A shown in FIG. 3B. If the distance from the current location to the second wall 212 is less than or equal to the predetermined distance (e.g., less than or equal to 5 cm, 3 cm, etc.), the autonomous mobile device 100 may move backwardly until the distance L is greater than the predetermined distance such that the autonomous mobile device 100 can make a turn along a curved path without colliding with the first wall 211. This current location may be used as the first location A shown in FIG. 3B.

In some embodiments, the autonomous mobile device 100 may detect the second wall 212 when colliding with the second wall 212 (e.g., a collision sensor mounted at or behind the front bumper may detect the collision). After colliding with the second wall 212, the autonomous mobile device 100 may move backwardly from the second wall 212 such that the distance L (shown in FIG. 3B) from the current location to the second wall 212 is greater than the predetermined distance, and the autonomous mobile device 100 can make a turn along a curved path without colliding with the first wall 211. The current location after the backward movement may be used as the first location A. The autonomous mobile device 100 may obtain coordinates for the current location A. Thus, in some embodiments, after determining detection of the obstacle (e.g., second wall 212), the first location A may be determined. The processor 190 may determine that the obstacle is detected by an obstacle detecting sensor, such as a Lidar sensor, the camera 125, and/or any other suitable proximity sensors. In some embodiments, the detection may be achieved through infrared diodes, time of flight (“TOF”) distance measuring sensors, etc. Other suitable methods may also be used for determining the first location A.

It is presumed that at the location A, the forward moving direction of the autonomous mobile device 100 (as indicated by the arrow) forms an acute angle θ with respect to the first wall 211. That is, the forward moving direction of the autonomous mobile device 100 may form the angle θ with respect to the y-axis shown in FIG. 3A. The x-y coordinate system shown in FIG. 3A may be a global coordinate system for the work environment (e.g., room) in which the autonomous mobile device 100 operates. As shown in FIG. 3B, at the location A, the autonomous mobile device 100 may determine a pose (e.g., location and orientation) of the autonomous mobile device 100 at a projected location B, which is a target location when the autonomous mobile device 100 may arrive when the autonomous mobile device 100 completes a turn following a curved path in the wall-following mode. The projected location B may be determined to be any suitable location adjacent the second wall 212 according to a predetermined movement control algorithm. For example, in some embodiments, the projected location B may be determined to be a location that is at a predetermined distance (e.g., 10 cm, 5 cm, etc.) from the second wall 212 and at another predetermined distance (e.g., 50 cm, 30 cm, etc.) from the current location A in the x-axis direction (or in a direction perpendicular to the first wall 211). These predetermined distances may be pre-set based on various factors, such as the size of the autonomous mobile device 100. The pose of the autonomous mobile device 100 at the projected location B may include the location and the orientation of the autonomous mobile device 100 at the projected location B. A location may be represented by coordinates in the x-y coordinate system. It is noted that the x-y coordinate system is merely an example coordinate system that may be used. Other coordinate systems (such as a polar coordinate system) may also be used, and transformation between different coordinate systems may be performed when needed. The determination of the pose of the autonomous mobile device 100 at the projected location B may be based on the pose of the autonomous mobile device 100 at the location A, the location of the obstacle (e.g., the second wall 212) in front of the autonomous mobile device 100, and a predetermined distance d in the x-axis direction (i.e., along the direction of the second wall 212, or in a direction perpendicular to the first wall 211). The predetermined distance d may be a length of the projection of the distance from the projected location B to the location A (i.e., projection of the segment AB) in the x-axis direction. The predetermined distance d is the distance between the current location A and the projected location B in the x-axis direction (i.e., the horizontal distance). In some embodiments, the orientation (or moving direction) of the autonomous mobile device 100 at the projected location B may be parallel with an edge of the obstacle (e.g., the second wall 212) facing the autonomous mobile device 100. In the scenario shown in FIG. 3A, the following parameters are presumed for discussion purposes: the width of one half of the autonomous mobile device is wr, the coordinates of the current location A of the autonomous mobile device are (x0, y0), and at the projected location B the distance from the left housing (e.g., the leftmost point of the left housing) of the autonomous mobile device 100 to the obstacle (e.g., second wall 212) is lw. Note that the coordinates (x0, y0) at the location A may be the coordinates of the center of the autonomous mobile device 100 (e.g., center of the example rectangle shape representing the autonomous mobile device 100). The pose, i.e., the coordinates and the orientation, of the autonomous mobile device 100 at the projected location B (if the autonomous mobile device 100 completes a projected turn) may be determined as follows. First, the y-axis coordinate of the obstacle (e.g., second wall 212) adjacent the projected location B may be determined as yw=y0+L. Here, it is presumed that the edge or boundary of the obstacle, e.g., second wall 212, facing the autonomous mobile device 100 is a straight line parallel with the x-axis. Based on the y-axis coordinate of the obstacle (e.g., second wall 212) adjacent the projected location B, the y-axis coordinate of the projected location B if the autonomous mobile device 100 completes the projected turn from the location A may be determined as: yb=y0+L−wr−lw. In some situations, if after completing the turn from the location A, the autonomous mobile device 100 can run along the second wall 212 at a very short distance lw, the distance lw may be treated as substantially 0 (although it may not be actually zero), and then yb may be approximated as yb=y0+L-wr. Based on the predetermined distance d in the x-axis direction, the x-axis coordinate of the projected location B after the autonomous mobile device 100 completes the projected turn from the location A may be determined as: xb=x0+d. The predetermined distance d is used to determine the horizontal coordinate xb (i.e., the x-axis coordinate in FIG. 3B) of the projected location B after the autonomous mobile device completes a projected turn from the location A. Accordingly, the coordinates of the projected location B may be determined as (x0+d, y0+L−wr−lw).

At the current location A, the autonomous mobile device 100 may determine the curved path (or arc) p1. The curved path (or arc) p1 connecting the location A and the projected location B may be determined as follows. Based on the current orientation of the autonomous mobile device 100 at the location A (e.g., facing direction or forward moving direction), as indicated by the arrow at the location A, and the orientation of the autonomous mobile device 100 at the projected location B (as indicated by the arrow at the projected location B), a center point of a target circle may be determined. The curved path p1 may be a portion of the target circle. First, connecting the location A and the projected location B to obtain a straight segment AB, as indicated by the dashed line connecting A and B. The segment AB forms an angle α with respect to the x-axis. Draw a perpendicular bisector 301 (i.e., a line that is perpendicular to the segment AB and that passes through the midpoint m1 of the segment AB). In theory, any point on the perpendicular bisector 301 to the right side of the segment AB may be used as the center of the target circle for generating the curved path (e.g., arc) p1. For example, taking any point on the perpendicular bisector 301, and drawing a circle passing through both location A and projected location B generates a curved path p1 (e.g., arc), which may be used as the projected moving path for the autonomous mobile device 100 to move from the location A to the projected location B. The center O may be selected such that turning along the curved path p1 would not cause any portion of the autonomous mobile device 100 to collide with the wall 211. In the example shown in FIG. 3B, a center O of the target circle may be determined as follows. Draw a line 302 that passes through the projected location B and that is parallel with the y-axis. The line 302 may also be parallel with the first wall 211. The line 302 may cross the perpendicular bisector 301 at the point O. The point O may be used as the center of the target circle for generating the curved path p1. The distance between the location B and the point O (represented by “BO”), or the distance between the location A and the point O (represented by “AO”), which are the same, may be used as the radius r of the target circle. Drawing a portion of the target circle forms the curved path p1 connecting the location A and the projected location B. For simplicity of illustration, only the arc portion p1 of the target circle is shown in the figure. The relationship between the radius r of the target circle and the predetermined distance d may be: d=r*sin (2a). Thus, when the predetermined distance d and the location B is known, the radius r of the target circle can be determined.

The coordinates of the center O of the target circle may be determined as (x0+d, y0+L−wr−lw−r). Based on the coordinates of the center O, the radius r of the target circle, the coordinates of the current location A, and the coordinates of the projected location B after making the turn, the arc (or the curved path p1) connecting the location A and the location B may be determined. The autonomous mobile device 100 may move from the location A to the location B along the determined curved path p1, rather than along substantially straight lines following the first wall 211 and the second wall 212 between the location A and the location B according to conventional technologies. After the autonomous mobile device 100 moves to the location B along the curved path p1, the autonomous mobile device 100 may continue to move in the wall-following mode, following the edge or boundary of the second wall 212. During the movement (e.g., turn) from the location A to the location B along the curved path p1, the motion-related parameters of the autonomous mobile device 100 may be set as follows: the linear velocity of the autonomous mobile device 100 may be a fixed value, the angular velocity=the linear velocity/r, the rotation angle from location A to location B=the angle between the segment OA and the segment OB.

A typical cornrow mode (or cornrow pattern) is shown in FIG. 3E. In the typical cornrow mode, the moving paths include a plurality of parallel long paths (L2, L3, and LA are example long paths) and a plurality of short, connecting paths (L23 and L34 are example connecting paths) that connect the adjacent parallel long paths. The autonomous mobile device 100 moves along a first long path L2 toward the left (i.e., in the −x-axis direction). When detecting an obstacle (e.g., the wall 311), the autonomous mobile device 100 may turn right for 90 degrees, and move along the connecting path L23 (e.g., in the +y-axis direction) for a predetermined distance b. In some embodiments, when the obstacle 311 is slanted (rather than being perpendicular to) the long paths L2, L3, and L4, the connecting paths L23 may be slanted as well (rather than being perpendicular to the long paths L2, L3, and LA). The predetermined distance b may also be referred to as a cornrow gap. Then the autonomous mobile device 100 may turn right for another 90 degrees to move along a second long path L3 to the right (i.e., in the +x-axis direction). At the right end, after having moved along the path L3 for a predetermined distance, or when the autonomous mobile device 100 detects another obstacle (not shown), the autonomous mobile device 100 may turn left for another 90 degrees to move along the connecting path L34 (e.g., in the +y-axis direction) for the predetermined distance b. After having moved for the predetermined distance b along the connecting path L34, the autonomous mobile device 100 may turn left for 90 degrees, and may move along a third long path LA. These movements may be repeated, forming the cornrow pattern. In conventional technologies, in the example cornrow pattern shown in FIG. 3E, the autonomous mobile device turns 90 degrees (or close to 90 degrees) from the first long path L2 to the connecting path L23 and then turns another 90 degrees (or close to 90 degrees) from the connecting path L23 to the second long path L3. The autonomous mobile device moves along a substantially straight line, i.e., the connecting path (e.g., L23) when transitioning from one long path (e.g., L2) to another parallel long path (e.g., L3).

FIG. 3C schematically illustrates movement control in a cornrow mode in conventional technologies. As shown in FIG. 3C, the horizontal direction is the x-axis, and the vertical direction is the y-axis. The autonomous mobile device 100 moves within a work environment in the cornrow mode. For example, the autonomous mobile device 100 moves from a location E along the first long path L2 in the cornrow mode. The autonomous mobile device 100 may detect an obstacle, such as the wall 311. The wall 311 may be detected while the autonomous mobile device 100 is away from the wall 311 at a distance, or may be detected when the autonomous mobile device 100 collides with the wall 311. Other detection methods may also be used. If the wall 311 is detected when the autonomous mobile device 100 is away from the wall 311 at a distance, the current location of the autonomous mobile device 100 may be used as a first location F shown in FIG. 3C. If the wall 311 is detected based on collision, the autonomous mobile device 100 may move backwardly for a predetermined distance, and the location after having moved backwardly for the predetermined location may be used as the first location F. In some embodiments, the autonomous mobile device 100 may determine the first location F after determining detection of the wall 311. Coordinates of the first location F may be obtained by the autonomous mobile device 100. In conventional technologies, the autonomous mobile device 100 may rotate or spin at the first location F for about 90 degrees to change its moving direction, from being in the −x-axis direction (i.e., perpendicular to the wall 311) to being in the +y-axis direction (i.e., parallel with the wall 311, assuming the wall 311 is straight). In conventional technologies, the autonomous mobile device 100 may move from the first location F to a second location F′. The distance between the first location F and the second location F′ may be the predetermined distance b, i.e., the cornrow gap. In conventional technologies, at the second location F′, the autonomous mobile device 100 may then rotate or spin for about 90 degrees to change its moving direction, from being parallel to the +y-axis direction to being parallel to the +x-axis direction, and may move in the +x-axis direction to a third location G. The third location G is also referred to as a direction-reversing point (or location). However, due to the non-circular shape of the autonomous mobile device 100 (here rectangular shape is used as an example), if the autonomous mobile device 100 rotates or spins for about 90 degrees at the first location F or the second location F′, and if the autonomous mobile device 100 is not sufficiently far away from the wall 311 at those locations, a portion of the autonomous mobile device 100 (e.g., the extended water tank at the rear portion) may collide with the wall 311, which may cause damages to the wall 311 and/or the autonomous mobile device 100. Thus, the present disclosure provides a method for controlling movement of the autonomous mobile device 100 in a cornrow mode that can help avoid collision with the wall 311, when the autonomous mobile device 100 has a non-circular shape. The disclosed method (an example is shown in FIG. 3D) is different from the conventional method shown in FIG. 3C.

The present disclosure provides a method for controlling movement (e.g., the turning) of the autonomous mobile device 100, such that the potential collision associated with turning in the cornrow mode may be avoided. FIG. 3D schematically illustrates an embodiment of the disclosed method for controlling movement (or movement control) of the autonomous mobile device 100 in a cornrow mode to avoid collision with a wall 311. Instead of taking the short connecting path L23 shown in FIG. 3C or 3E (which may be perpendicular to the long path L2), as in conventional technologies, according to the disclosed movement control method, the autonomous mobile device 100 of the present disclosure may follow a curved path as shown in FIG. 3D to turn from one long path L2 to another adjacent long path L3. The curved path may connect the current location F on the long path L2 and the projected location G on the long path L3. With the disclosed movement control method, to move from the first long path L2 to the second long path L3, the autonomous mobile device 100 may not follow the major portions of the connecting path L23 and a portion (as represented by dG) of the second long path L3, which are typically followed in conventional technologies. With the disclosed movement control method, the potential collision with the obstacle (e.g., wall 311) associated with spinning at the same location for a mobile device having a non-circular shape may be avoided. In addition, the travel distance when transitioning from one long path to another long path in a cornrow mode is also reduced by taking the curved path p11, as shown in FIG. 3D.

In the movement control method shown in FIG. 3D, when the autonomous mobile device 100 moves along the first long path L2, the autonomous mobile device 100 may detect the obstacle 311 (e.g., wall 311). Various methods described above may be used to detect the obstacle.

For example, in some embodiments, an obstacle detection sensor may detect the wall 311 at a distance from the autonomous mobile device 100. If the distance is greater than a predetermined distance such that the autonomous mobile device 100 can make a turn along a curved path from the current location to the projected location G without colliding with the wall 311, the current location may be used as the first location F. If the distance is less than or equal to the predetermined distance (i.e., not sufficient for the autonomous mobile device 100 to make a turn along a curved path from the current location to the projected location G without colliding with the wall 311), the autonomous mobile device 100 may move backward along the reverse direction of the first long path L2 until the distance from the current location to the wall 311 is greater than the predetermined distance. The current location may be used as the first location F. After the first location F is determined, the autonomous mobile device 100 may rotate for 90 degrees to face the +y-axis direction, as shown in FIG. 3D.

In some embodiments, a collision sensor may detect collision of the autonomous mobile device 100 with the wall 311, thereby detecting the wall 311. If the wall 311 is detected based on collision, the autonomous mobile device 100 may move backwardly along the reverse direction of the first long path L2 until the distance from the current location to the wall 311 is greater than the predetermined distance such that the autonomous mobile device 100 can make a turn along a curved path from the current location to the projected location G without colliding with the wall 311. After the autonomous mobile device 100 has moved backwardly for the predetermined distance, the current location of the autonomous mobile device 100 may be used as the first location F.

The first location F may be determined after determining the detection of the obstacle (e.g., wall 311). The autonomous mobile device 100 may determine the coordinates of the first location F. The autonomous mobile device 100 may determine the pose (e.g., coordinates and orientation) of the autonomous mobile device 100 at the projected location G. The projected location G (also referred to as the direction-reversing point) is located on the second long path L3, which is parallel with the current moving path, i.e., the first long path L2 where the first location F is located. The projected location G may be selected based on a variety of factors. For example, in some embodiments, the projected location G may be selected to be a predetermined distance dG in the x-axis direction from the first location F. The predetermined distance dG may be pre-set. The pose of the autonomous mobile device 100 at the first location F may include coordinates and orientation. The coordinates of the autonomous mobile device 100 at the first location F may be determined as (x1, y1), the orientation of the autonomous mobile device 100 may be the +y-axis (or y-axis) direction. The predetermined distance dG may be equal to the length of the projection of the distance between the projected location G (which may be the third location G shown in FIG. 3C) and the first location F onto the horizontal coordinate axis, i.e., the x-axis. That is, dG may be the length of the projection of segment FG onto x-axis, i.e., the horizontal distance between the first location F and the projected location G. The distance between adjacent parallel long paths L2 and L3 (or rows in the cornrow mode) may be represented by the cornrow gap b, which is equal to the projection of the distance between the projected location G and the first location F onto the vertical coordinate axis, i.e., the y-axis. The distance b may be pre-set. The coordinates of the projected location G may be (x1+dG, y1+b).

Because in a cornrow mode, at the location G, the moving direction of the autonomous mobile device 100 is predetermined, i.e., the +x-axis direction, the orientation of the autonomous mobile device 100 at the location G may be determined as the +x-axis direction. As such, the pose of the autonomous mobile device 100 at the location G may be determined.

According to the movement control method disclosed herein, the autonomous mobile device 100 may move from the first location F to the projected location G through a curved path (or arc) p11. In some embodiments, the curved path p11 may be a portion of a target circle. The target circle and the curved path p11 may be determined as follows. Based on the pose of the autonomous mobile device 100 at the first location F, the pose of the autonomous mobile device 100 at the direction-reversing location G, the predetermined distance dG, and the predetermined distance b between adjacent parallel paths in the cornrow mode (or the cornrow gap b), the autonomous mobile device 100 may determine the center point O of the target circle. For example, in some embodiments, a segment FG may be formed by connecting the locations F and G. The angle between the segment FG and the x-axis may be denoted by B. The midpoint of the segment FG may be denoted by m2. Draw a perpendicular bisector pb passing through the middle point m2 and being perpendicular to the segment FG. In theory, any point on the perpendicular bisector pb to the right of the segment FG may be used as the center of the target circle. The center O may be selected such that turning along the curved path p11 would not cause any portion of the autonomous mobile device 100 to collide with the wall 311. Based on the selected center O, and using the distance between the first location F and the center O (“OF”) or the distance between the center O and the projected location G (“OG”) as the radius r, drawing an arc passing through both the first location F and the projected location G generates the curved path p11 (or arc) for moving the autonomous mobile device 100. The curved path p11 (or arc) is part of the target circle. For simplicity of illustration, only the arc p11 of the target circle is shown in FIG. 3D. An example method for obtaining the center O is described below: draw a line passing through the projected location G that is parallel with the y-axis, the crossing point between this line and the perpendicular bisector pb is the center O. The radius r is the length of the segment OF or the segment OG. The relationship between the radius r and the predetermined distance dG may be determined as: dG=r*sin (2 β), where tan (B)=b/dG. Thus, when the predetermined distance dG and the cornrow gap b are known, the radius r of the target circle can be determined.

Based on the determined radius of the target circle, the coordinates of the center O of the target circle can be calculated as: (x1+dG, y1+b−r). The curved path p11 (i.e., the arc of the target circle between the first location F and the projected location G) may be determined based on the coordinates of the first location F, the coordinates of the projected location G, the coordinates of the center O, and the radius r of the target circle. The curved path p11 may be used as the travel path for the autonomous mobile device 100 when the autonomous mobile device 100 makes a turn from the first location F on the first long path L2 to the projected location G on the second long path L3 in the cornrow mode. The autonomous mobile device 100 may move from the first location F to the projected location G following the curved path p11 (or arc), and then continue to move from the projected location G in a pre-set moving direction (which is the +x-axis direction) along the path L3. During the movement (e.g., turn) from the first location F to the projected location G along the curved path p11, the motion-related parameters of the autonomous mobile device 100 may be set as follows: the linear velocity of the autonomous mobile device 100 may be a fixed value, the angular velocity=the linear velocity/r, the rotation angle from the first location F to the projected location G=the angle between the segment OF and the segment OG.

FIG. 3F and FIG. 3G schematically illustrate control of the movement of the autonomous mobile device 100 in the cornrow mode to avoid collision with a wall 311, according to another embodiment of the present disclosure. FIG. 3F shows that the autonomous mobile device 100 moves along a first long path L2 from the location E. The autonomous mobile device 100 may detect an obstacle (e.g., the wall 311) in the moving direction based on the obstacle detection methods described above in connection with FIG. 3D. After the wall 311 is detected, the first location F may be determined. The obstacle detection and the determination of the first location F can refer to the above descriptions rendered in connection with FIG. 3D. The coordinates of the first location F may be obtained by the autonomous mobile device 100. The autonomous mobile device 100 may determine a first curved path for moving from the first location F on the first long path L2 to a first projected location H, which may be located on the connecting path L23. Then, when the autonomous mobile device 100 arrives at the first projected location H along the first curved path, the autonomous mobile device 100 may determine a second curved path for moving from the first projected location H to a second projected location G located on the second long path L3. Alternatively, the second curved path may be determined together with the first curved path while the autonomous mobile device 100 is at the first location. Thus, in this embodiment, the autonomous mobile device 100 may follow two curved paths when moving from one location (e.g., F) on the first long path L2 of a cornrow pattern to another location (e.g., G) on the second long path L3 of the cornrow pattern. The two curved paths are formed between the first location F on the first long path L2 and the first projected location H on the connecting path L23, and between the first projected location H on the connecting path L23 and the second projected location G on the second long path L3. The autonomous mobile device 100 may not move in parallel with the obstacle (e.g., wall 311) along the path L23 when transitioning from the location F to the location G. In some embodiments, the autonomous mobile device 100 may only traverses the connecting path L23 at the first projected location H, or within a small distance around the first projected location H that is negligible as compared to the full length of the connecting path L23. It is understood that the first projected location H may or may not be on the connecting path L23. For example, the first projected location H may be on a line parallel with the connecting path L23. For discussion purposes, the first projected location H is presumed to be on the connecting path L23.

According to the disclosed movement control method, at the first location F, the autonomous mobile device 100 may determine a pose (e.g., coordinates and orientation) of the autonomous mobile device 100 at the first projected location H if the autonomous mobile device 100 makes a turn from the first location F following a curved path (which is to be determined). The first projected location H may be selected through a suitable algorithm. For example, in one embodiment, the first projected location H may be selected to have a first predetermined distance d1 from the first location F in the y-axis direction (or in the extending direction of the detected obstacle 311). An example of the first projected location H may be selected to be a point such that the distance d1 is ½, ⅓, or any other fraction, of the entire length of the connecting path L23 (or the cornrow gap b). It is noted that in FIG. 3F, only a portion of the connecting path L23 is shown as dashed lines since the autonomous mobile device 100 does not follow the full connecting path L23 when controlled by the disclosed movement control method. The pose of the autonomous mobile device 100 at the first projected location H may be determined as follows. At the first location F, the autonomous mobile device 100 may detect an obstacle at a distance Lf in the moving direction of the autonomous mobile device 100. Here, the wall 311 is used as an example of the obstacle. Based on the pose (e.g., coordinates and orientation) of the autonomous mobile device 100 at the first location F, the location (e.g., coordinates) of the obstacle (e.g., the coordinates of a point on the wall 311 that is a crossing point between the wall 311 and the extension line of the path L2), the first predetermined distance d1, the autonomous mobile device 100 may determine, when at the first location F, the pose of the autonomous mobile device 100 at the first projected location H if the autonomous mobile device 100 makes the turn from the first location F to the first projected location H. The pose of the autonomous mobile device 100 includes the position (e.g., coordinates) and the orientation. The first predetermined distance d1 may be a length of the projection of the distance between the first location F and the projected location H in the y-axis direction, i.e., segment FH projected onto the y-axis. That is, the first predetermined distance d1 may be the distance between the first location F and the first projected location H in the y-axis direction. In some embodiments, the orientation of the autonomous mobile device 100 at the first projected location H may be a direction parallel with an edge of the obstacle facing the autonomous mobile device (e.g., the wall 311). In the embodiment shown in FIG. 3F, it is presumed that the edge or boundary of the obstacle (e.g., wall 311) facing the autonomous mobile device 100 is a straight line parallel with the y-axis. The orientation of the autonomous mobile device 100 at the first projected location H is in the +y-axis direction. Presuming that the width of half of the autonomous mobile device 100 is represented by wr, the coordinates of the first location F are represented by (x2, y2), the horizontal distance between the autonomous mobile device 100 and the wall 311 at the first projected location H is represented by lw, then the x-axis coordinate of the obstacle (e.g., wall 311) may be determined as xw1=x2−Lf. Based on the x-axis coordinate of the obstacle (e.g., wall 311), the x-axis coordinate for the first projected location H may be determined as: xh=x2−Lf+wr+lw. When the autonomous mobile device 100 at the first projected location H is very close to the obstacle (e.g., wall 311), the distance lw may be approximately 0, then the x-axis coordinate of the first projected location H may be simplified as xh=x2−Lf+wr.

Based on the first predetermined distance d1, the y-axis coordinate of the first projected location H may be determined as yh=y2+d1. Here, the first predetermined distance d1 is pre-set, such that the y-axis coordinate of the first projected location H can be determined. The coordinates of the first projected location H if the autonomous mobile device 100 makes a turn from the location F may be determined as (x2−Lf+wr+lw, y2+d1).

Before the autonomous mobile device 100 moves from the first location F to the first projected location H, the autonomous mobile device 100 may determine a first target circle and a first curved path (or arc) p21 as follows. Based on the orientation of the autonomous mobile device 100 at the first location F and the orientation of the autonomous mobile device 100 at the first projected location H (if the autonomous mobile device 100 makes a turn), a first center of the first target circle may be determined. Connecting the locations F and H may obtain a segment FH. A perpendicular bisector pb1 of the segment FH may be drawn. The perpendicular bisector pb1 passes through a midpoint m3, and is perpendicular to the segment FH. In theory, any point on the perpendicular bisector pb1 to the right of the segment FH may be used as the first center of the first target circle for generating the first curved path p21 (or arc p21) for moving the autonomous mobile device 100 from the first location F to the first projected location H. The center may be selected such that when making the turn from the location F to the first projected location H, any portion of the autonomous mobile device 100 would not collide with the wall 311. The first radius r1 is the distance between the first center and the first location F or the first projected location H. As an example, in the embodiment shown in FIG. 3F, the first center O1 of the first target circle is determined as follows. From the first projected location H, draw a line parallel with the x-axis. The line crosses with the perpendicular bisector pb1 at the point O1. This point O1 may be used as the first center of the first target circle. The first radius r1 of the first target circle is the distance between O1 and the first location F, or the distance between O1 and the location H. The relationship between the first radius r1 of the first target circle and the first predetermined distance d1 may be determined as: d1=r1*sin (2 α1), where tan (α1)=(Lf−lw−wr)/d1. As shown in FIG. 3F, the angle α1 is the angle formed by the segment FH with an axis passing through a center point of the autonomous mobile device 100 and being parallel with the +y-axis. Thus, when the position (e.g., coordinates) of the first location F, the position (e.g., coordinates) of the first projected location H, the first predetermined distance d1, and the distance Lf from the first location F of the autonomous mobile device 100 to the obstacle in the forward moving direction (e.g., the wall 311), the first radius r1 of the first target circle may be determined.

The coordinates of the first center of the first target circle may be determined as (x2−Lf+wr+lw+r1, y2+d1). Based on the coordinates of the first center O1, the first radius r1 of the first target circle, the coordinates of the first projected location H, the first curved path p21 (or arc p21) connecting the first location F and the first projected location H may be determined. The autonomous mobile device 100 may move from the first location F to the first projected location H along the first curved path p21. During the movement (e.g., turn) from the first location F to the first projected location H along the first curved path p21, the motion-related parameters of the autonomous mobile device 100 may be set as follows: the linear velocity of the autonomous mobile device 100 may be a fixed value, the angular velocity=the linear velocity/r1, the rotation angle from the first location F to the first projected location H=the angle between the segments O1F and O1H.

As shown in FIG. 3G, the autonomous mobile device 100 may move from the first projected location H to the direction-reversing location G (the second projected location G) following a second curved path p22. In some embodiments, the autonomous mobile device 100 may select the second projected location G when it arrives at the first projected location H, and may determine the second curved path p22. In some embodiments, the autonomous mobile device 100 may select the first projected location H and the second projected location G, and determine the first curved path p21 and the second curved path p22 while the autonomous mobile device 100 is at the first location F. The following method may be used for determining the second curved path p22. First, the pose (e.g., coordinates and orientation) of the autonomous mobile device 100 at the direction-reversing location G may be determined. The pose of the autonomous mobile device 100 at the first projected location H may include coordinates and orientation. From the above calculation, the coordinates of the first projected location H are (xh, yh)=(x2−Lf+wr+lw, y2+d1), and the orientation of the autonomous mobile device 100 at the first projected location H is in the +y-axis direction. A second predetermined distance d2 may be pre-set. The second predetermined distance d2 may determine the second projected location G. The second predetermined distance d2 may represent the distance between the first location F and the second projected location G in the x-axis direction, i.e., the horizontal distance. The second predetermined distance d2 may be equal to a length of the projection of the distance between the first location F and the direction-reversing location G on the horizontal axis, i.e., the x-axis. The coordinates of the second projected location G may be determined as (x2+d2, y2+b), where (x2, y2) are coordinates of the first location F.

In a cornrow mode, when the autonomous mobile device 100 arrives at the location G, the autonomous mobile device 100 continues to move in the +x-axis direction. Thus, the orientation of the autonomous mobile device 100 at the second projected location G is the +x-axis direction. As such, the pose (which includes the coordinates and orientation) of the autonomous mobile device 100 at the second projected location G can be determined.

The second target circle and the second curved path p22 (or arc p22) may be determined as follows. Based on the pose (e.g., coordinates and orientation) of the autonomous mobile device 100 at the first location F, the location (e.g., coordinates) of the autonomous mobile device 100 at the first projected location H, the pose of the autonomous mobile device 100 at the second projected location G, the first predetermined distance d1, the second predetermined distance d2, the predetermined distance b (or cornrow gap b), the second center O2 of the second target circle may be determined. Connecting the first projected location H and the second projected location G forms a segment HG. The angle between the segment HG and the y-axis is presumed to be γ. Draw a perpendicular bisector pb2 for the segment HG. In theory, any point on the perpendicular bisector pb2 to the right of the segment HG may be used as the second center of the second target circle, and the distance between the center and the location H or the location G may be used as the second radius. The second center may be selected such that when the autonomous mobile device 100 moves along the second curved path, any portion of the autonomous mobile device 100 would not collide with the wall 311. Thus, the second target circle may be determined. As an example, the second center O2 of the second target circle in the embodiment shown in FIG. 3G is obtained as follows. Draw a perpendicular bisector pb2 for the segment HG. The perpendicular bisector pb2 passes through a midpoint m4 of the segment HG, and is perpendicular to the segment HG. Draw a line passing through the location G and being parallel with the y-axis. This line crosses with the perpendicular bisector pb2 at the point O2. The point O2 is used as the second center of the second target circle, and the distance between the point O2 and the first projected location H or the second projected location G is used as the second radius r2. The relationship between the second radius r2 of the second target circle, the second predetermined distance d2, and the distance b between two adjacent parallel long paths in the cornrow pattern (or the cornrow gap b) may be determined as: d2+Lf−lw−wr=r2*sin (2γ), where tan (γ)=(b−d1)/(d2+Lf−lw−wr). Thus, when the first predetermined distance d1, the second predetermined distance d2, and the distance b between two adjacent parallel long paths in the cornrow pattern are known, the second radius r2 of the second target circle may be calculated.

Based on the coordinates of the second projected location G and the second radius r2 of the second target circle, the coordinates of the second center O2 of the second target circle may be determined as (x2+d2, y2+b−r2). Based on the coordinates of the location F, the coordinates of the second projected location G, the coordinates of the second center O2, and the second radius r2 of the second target circle, the second curved path p22 (or arc p22) connecting the first projected location H and the second projected location G may be determined. The second curved path p22 is a portion of the second target circle, and passes both the first projected location H and the second projected location G. The second curved path p22 may be used as the travel path for the autonomous mobile device 100 to move from the first projected location H to the second projected location G. The autonomous mobile device 100 moves from the first projected location H to the second projected location G along the second curved path p22, and at the second projected location G, the autonomous mobile device 100 may continue to move in the pre-set direction (i.e., the +x-axis direction in this embodiment) of the cornrow mode. During the movement (e.g., turn) from the first projected location H to the second projected location G along the second curved path p22, the motion-related parameters of the autonomous mobile device 100 may be set as follows: the linear velocity of the autonomous mobile device 100 may be a fixed value, the angular velocity=the linear velocity/r2, the rotation angle from the first projected location H to the second projected location G=the angle between the segments O2H and O2G.

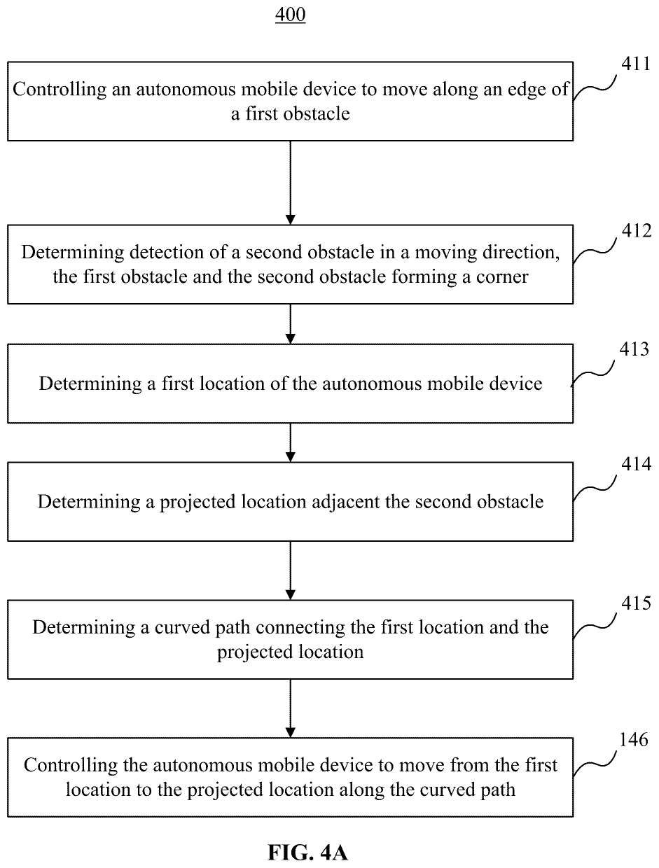

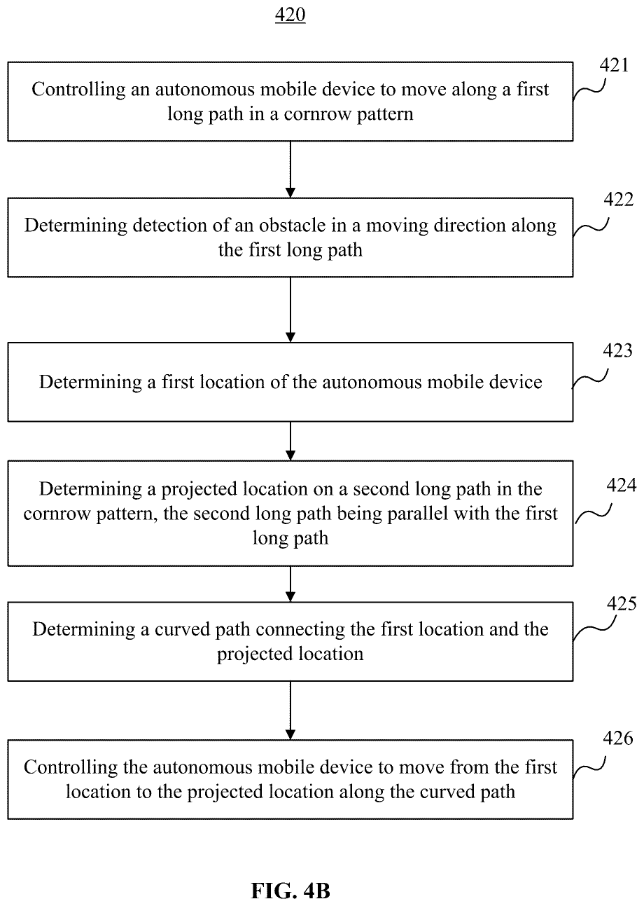

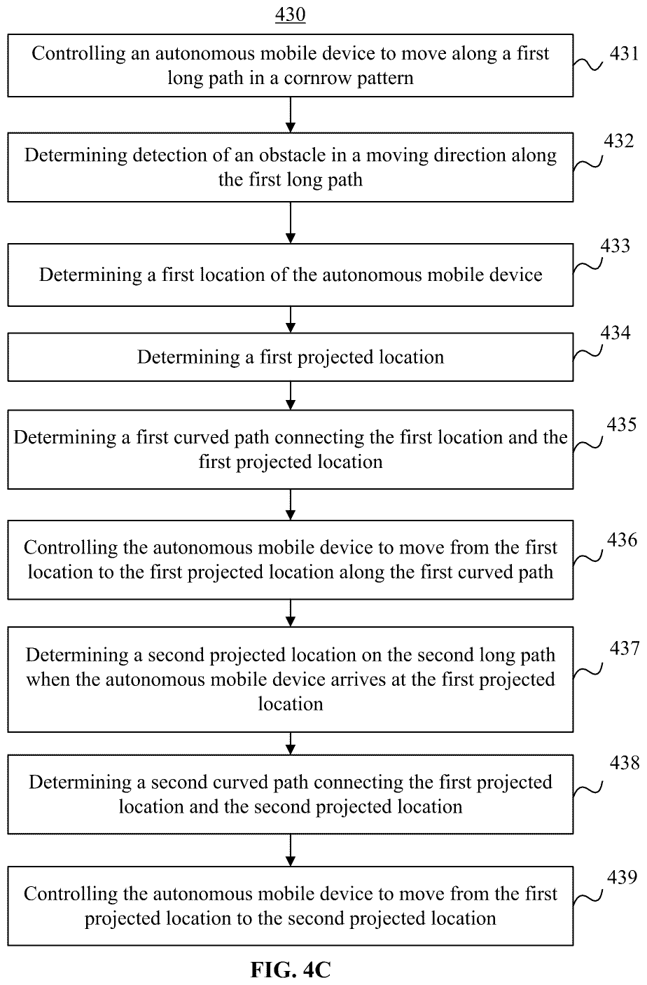

FIG. 4A is a flowchart showing a method 400 for controlling movement of an autonomous mobile device, according to an embodiment of the present disclosure. The method 400 corresponds to the movement control described above in connection with FIG. 3B. Although not shown, the method 400 may include additional steps described above in connection with FIG. 3B, or one or more steps shown in FIG. 4A may be omitted from the method 400. The order in which the steps are performed is not limited to the order shown in FIG. 4A. The method 400 may be executed by the processor 190 of the autonomous mobile device 100. The method 400 may include controlling an autonomous mobile device to move along an edge of a first obstacle (step 411). The method 400 may also include determining detection of a second obstacle in a moving direction, the first obstacle and the second obstacle forming a corner (step 412). The method 400 may also include determining a first location of the autonomous mobile device (step 413). In some embodiments, determining the first location may be performed after determining the detection of the second obstacle. The method 400 may also include determining a projected location adjacent the second obstacle (step 414). The method 400 may include determining a curved path connecting the first location and the projected location (step 415). The method 400 may include controlling the autonomous mobile device to move from the first location to the projected location along the curved path (step 416).

FIG. 4B is a flowchart showing a method 420 for controlling movement of an autonomous mobile device, according to an embodiment of the present disclosure. The method 420 may be performed by the processor 190 of the autonomous mobile device 100. The method 420 corresponds to the movement control described above in connection with FIG. 3D. Although not shown, the method 420 may include additional steps described above in connection with FIG. 3D, or one or more steps shown in FIG. 4B may be omitted from the method 420. The method 420 may include controlling an autonomous mobile device to move along a first long path in a cornrow pattern (step 421). The method 420 may also include determining detection of an obstacle in a moving direction along the first long path (step 422). The method 420 may include determining a first location of the autonomous mobile device (step 423). In some embodiments, determining the first location may be performed after determining the detection of the obstacle. The method 420 may include determining a projected location on a second long path in the cornrow pattern, the second long path being parallel with the first long path (step 424). The method 420 may include determining a curved path connecting the first location and the projected location (step 425). The method 420 may include controlling the autonomous mobile device to move from the first location to the projected location along the curved path (step 426). In some embodiments, the method 420 may also include rotating the autonomous mobile device for 90 degrees at the first location after determining detection of the obstacle, such that the moving direction of the autonomous mobile device is perpendicular to the first long path or parallel with an edge of the obstacle facing the autonomous mobile device.

FIG. 4C is a flowchart showing a method 430 for controlling movement of an autonomous mobile device, according to an embodiment of the present disclosure. The method 430 may be performed by the processor 190 of the autonomous mobile device 100. The method 430 corresponds to the movement control described above in connection with FIGS. 3F and 3G. Although not shown, the method 430 may include additional steps described above in connection with FIGS. 3F and 3G, or one or more steps shown in FIGS. 3F and 3G may be omitted from the method 430. The method 430 may include controlling an autonomous mobile device to move along a first long path in a cornrow pattern (step 431). The method 430 may include determining detection of an obstacle in a moving direction along the first long path (step 432). The method 430 may include determining a first location of the autonomous mobile device (step 433). In some embodiments, determining the first location may be performed after determining detection of the obstacle. The method 430 may include determining a first projected location (step 434). The method 430 may include determining a first curved path connecting the first location and the first projected location (step 435). The method 430 may include controlling the autonomous mobile device to move from the first location to the first projected location along the first curved path (step 436). The method 430 may include determining a second projected location on the second long path when the autonomous mobile device arrives at the first projected location (step 437). The method 430 may include determining a second curved path connecting the first projected location and the second projected location (step 438). The method 430 may include controlling the autonomous mobile device to move from the first projected location to the second projected location (step 439).

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A method for controlling movement of an autonomous mobile device, comprising:
controlling the autonomous mobile device to move along an edge of a first obstacle;
determining detection of a second obstacle in a moving direction, the first obstacle and the second obstacle forming a corner;
determining a first location of the autonomous mobile device;
determining a projected location adjacent the second obstacle;
determining a curved path connecting the first location and the projected location; and
controlling the autonomous mobile device to move from the first location to the projected location along the curved path.

2. The method of claim 1, wherein determining the curved path includes:
determining a center of a target circle; and
determining a radius of the target circle, the radius being a distance between the center and one of the first location and the projected location.

3. The method of claim 2, wherein determining the center of the target circle includes:
determining a segment between the first location and the projected location;
determining a perpendicular bisector of the segment; and
determining a point on the perpendicular bisector as the center of the target circle.

4. The method of claim 1, wherein
determining detection of the second obstacle includes determining detection of collision with the second obstacle,
the method further includes controlling the autonomous mobile device to move backwardly for a predetermined distance, and
determining the first location includes obtaining coordinates of the autonomous mobile device after the autonomous mobile device has moved backwardly for the predetermined distance.

5. The method of claim 1, wherein
determining detection of the second obstacle includes determining whether a distance between a current location and the second obstacle is less than or equal to a predetermined distance, and
based on a determination that the distance between the current location and the second obstacle is less than or equal to the predetermined distance, the method further includes moving the autonomous mobile device backwardly until the distance between the current location and the second obstacle is greater than the predetermined distance.

6. An autonomous mobile device, comprising:
a sensor configured to detect an obstacle;
a motion unit configured to move the autonomous mobile device along a surface; and
a processor configured to control the motion unit to control movement of the autonomous mobile device based on detection of the obstacle, wherein the processor is configured to perform a method including:
controlling the motion unit to move the autonomous mobile device to along an edge of a first obstacle;
determining detection of a second obstacle in a moving direction, the first obstacle and the second obstacle forming a corner;
determining a first location of the autonomous mobile device;
determining a projected location adjacent the second obstacle;
determining a curved path connecting the first location and the projected location; and
controlling the motion unit to move the autonomous mobile device from the first location to the projected location along the curved path.

7. The autonomous mobile device of claim 6, wherein the processor is further configured to:
determine a center of a target circle; and
determine a radius of the target circle, the radius being a distance between the center and one of the first location and the projected location.

8. The autonomous mobile device of claim 7, wherein when the processor determines the center of the target circle, the processor is further configured to:
determine a segment between the first location and the projected location;
determine a perpendicular bisector of the segment; and
determine a point on the perpendicular bisector as the center of the target circle.

9. The autonomous mobile device of claim 6,
wherein when the processor determines detection of the second obstacle, the processor is further configured to determine detection of collision with the second obstacle,
wherein the processor is further configured to control the autonomous mobile device to move backwardly for a predetermined distance, and
wherein when the processor determines the first location, the processor is further configured to obtain coordinates of the autonomous mobile device after the autonomous mobile device has moved backwardly for the predetermined distance.

10. The autonomous mobile device of claim 6,
wherein when the processor determines detection of the second obstacle, the processor is further configured to determine whether a distance between a current location and the second obstacle is less than or equal to a predetermined distance, and
wherein when the processor determines that the distance between the current location and the second obstacle is less than or equal to the predetermined distance, the processor is further configured to move the autonomous mobile device backwardly until the distance between the current location and the second obstacle is greater than the predetermined distance.

11. A non-transitory computer-readable storage medium storing instructions, wherein when the instructions are executed by a processor of an autonomous mobile device, the instructions cause the processor to perform a method for controlling movement of the autonomous mobile device, the method comprising:
controlling the autonomous mobile device to move along an edge of a first obstacle;
determining detection of a second obstacle in a moving direction, the first obstacle and the second obstacle forming a corner;
determining a first location of the autonomous mobile device;
determining a projected location adjacent the second obstacle;
determining a curved path connecting the first location and the projected location; and
controlling the autonomous mobile device to move from the first location to the projected location along the curved path.

12. The non-transitory computer-readable storage medium of claim 11, determining the curved path includes:
determining a center of a target circle; and
determining a radius of the target circle, the radius being a distance between the center and one of the first location and the projected location.

13. The non-transitory computer-readable storage medium of claim 12, wherein determining the center of the target circle includes:
determining a segment between the first location and the projected location;
determining a perpendicular bisector of the segment; and
determining a point on the perpendicular bisector as the center of the target circle.

14. The non-transitory computer-readable storage medium of claim 11, wherein
determining detection of the second obstacle includes determining detection of collision with the second obstacle,
the method further includes controlling the autonomous mobile device to move backwardly for a predetermined distance, and
determining the first location includes obtaining coordinates of the autonomous mobile device after the autonomous mobile device has moved backwardly for the predetermined distance.

15. The non-transitory computer-readable storage medium of claim 11, wherein
determining detection of the second obstacle includes determining whether a distance between a current location and the second obstacle is less than or equal to a predetermined distance, and
based on a determination that the distance between the current location and the second obstacle is less than or equal to the predetermined distance, the method further includes moving the autonomous mobile device backwardly until the distance between the current location and the second obstacle is greater than the predetermined distance.
